(19) United States
(12) Patent Application Publication
(10) Pub. No.: US 2026/0264102 A1
(43) Pub. Date: Sep. 10, 2026

(54) ADJUSTABLE RAINFALL SHOWERHEAD MOUNTING SYSTEM FOR NON-INVASIVE INSTALLATION

(71) Applicant: 15494796 Canada Inc., Gatineau (CA)

(72) Inventor: Vincent Raymond Marcel GAGNE, Gatineau (CA)

(21) Appl. No.: 19/587,215

(22) PCT Filed: Oct. 17, 2024
(86) PCT No.: PCT/CA2024/051362

§ 371 Date: May 13, 2026

Related U.S. Application Data
(60) Provisional application No. 63/598,844, filed on Nov. 14, 2023.

(51) Int. Cl. B05B 15/658; B05B 1/18

(52) U.S. Cl. CPC B05B 15/658; B05B 1/18

(57) ABSTRACT

A showerhead mounting system, typically for installing showerheads that are generally centrally located in the shower space is provided. The showerhead mounting system comprises a support bar adapted for being placed between two opposing walls of a shower and mounted thereto. A housing is adapted for accommodating the support bar therein such that a top thereof is in contact with the support bar. The housing or at least a section of the housing is movable along the support bar. A connecting mechanism is mounted to a bottom of the housing at a first end thereof such that the first end of the connecting mechanism is protruding through an opening disposed in the bottom of the housing or the at least a movable section of the housing. The first end of the connecting mechanism is adapted for being connected to a showerhead. A water conduit is connected to a second end of the connecting mechanism at a first end thereof. A second end of the water conduit is adapted for being connected to plumbing of the shower. At least a portion of the water conduit comprises a hose for enabling movement of the housing or at least a section of the housing along the support bar with the water conduit being connected to the plumbing and the connecting mechanism.

### FIELD

The present invention relates to the field of bathroom fixtures, and more particularly to an adjustable rainfall showerhead mounting system for non-invasive installation without altering the plumbing of the bathroom.

### BACKGROUND

Standard shower configurations typically involve plumbing disposed in one of the shower walls and a fixed showerhead positioned in close proximity to the shower wall at a height determined by the plumbing of the building. These fixed positions in close proximity to the shower wall can be less than optimal for users of different heights and can limit the shower experience.

The market has seen several attempts to address the limitations of standard shower configurations. For instance, adjustable shower arms and sliding rails provide some level of vertical movement of the showerhead. However, these solutions often offer limited positioning flexibility and may not adequately cater to the user's desire for a showerhead position that is not only higher but also more centrally located, or generally centrally located, in the shower space, or that is movable along the length of the shower space.

Moreover, the installation of specialized showerheads, such as rainfall showerheads that provide a unique and luxurious showering experience, often requires significant modifications to the existing plumbing structure, which can be costly and impractical, especially in rental properties where alterations are restricted.

Additionally, while certain products have been developed to retrofit standard shower configurations to support rainfall showerheads, these often require the showerhead to be placed in close proximity to the shower wall. Users typically find that these retrofit solutions do not offer the coverage and comfort expected of a rainfall shower due to the placement of the rainfall showerhead in close proximity to the shower wall.

Another challenge faced when retrofitting standard shower configurations is the risk of damage to the existing plumbing from the installation of aftermarket devices. Many shower retrofitting solutions apply significant stress to the plumbing fixtures due to the weight and leverage of extended arms or bulky adapters. This can lead to long-term damage to the plumbing fixtures and is a particular concern for renters who may be liable for any damages caused during their tenancy.

U.S. Pat. No. 11,987,963 discloses a shower assembly including a telescoping rod assembly for placement between opposing walls. The rod assembly includes an outer rod having opposite open ends and a spring-biased inner rod mounted inside the outer rod for axial movement in relation to the outer rod such as to allow adjustment of an axial length of the rod assembly. A control valve can be attached to a water-supply line for controlling discharge of water from the water-supply line. A tubular member having one end connected to the valve and another end enters a valve-proximate one of the open ends of the outer rod. A primary shower head is connected to the other end of the tubular member at a location distal to the valve-proximate one of the open ends. This device, while being easily installed using a telescoping rod assembly, does not enable a user to easily change the position of the showerhead within the shower space.

U.S. Pat. Nos. 8,925,747B1, 6,216,287B1, 8,479,932B2, US20120284914A1, and US20120241399A1 disclose various configurations of a telescoping rod assembly for placement between opposing walls for hanging a shower curtain therefrom. The disclosed devices are easily installed without compromising the integrity of the shower walls.

There is a need for a showerhead mounting system that allows for easy installation of a showerhead that is more centrally located, or generally centrally locatable, in the shower space without altering or damaging the existing plumbing of the bathroom. There is also a need for a showerhead mounting system that enables a user to easily change the position of the showerhead within the shower space. The ability to enhance the showering experience without incurring the expense and complexity of traditional installations would fulfil a keenly felt need among consumers for a personalized and adaptable showering environment.

This background information is provided for making information believed by the applicant to be of possible relevance to the present application. No admission is necessarily intended, nor should be construed, that any of the preceding information constitutes prior art against the subject matter presented herein.

### SUMMARY

An aspect of the present application is to provide a showerhead mounting system that allows for easy installation of a showerhead that is generally centrally located in the shower space without altering or damaging the existing plumbing of the bathroom and that enables a user to easily change the position of the showerhead within the shower space, for example along the length of the shower space.

In accordance with one aspect, the present application provides a showerhead mounting system typically for installing a showerhead that is generally centrally locatable in the shower space without altering the existing plumbing of the bathroom and enables a user to easily change the position of the showerhead within the shower space. The showerhead mounting system comprises a support assembly comprising a support bar and a first and a second mounting element connected to a respective first and second end of the support bar. The support assembly is adapted for being placed between two opposing walls of a shower and mounted thereto. A housing is adapted for accommodating the support bar therein such that a top thereof is in contact with the support bar. The housing or at least a section of the housing is movable along the support bar. A connecting mechanism is mounted to a bottom of the housing at a first end thereof such that the first end of the connecting mechanism is protruding through an opening disposed in the bottom of the housing or the at least a movable section of the housing. The first end of the connecting mechanism is adapted for being connected to a showerhead. A water conduit is connected to a second end of the connecting mechanism at a first end thereof. A second end of the water conduit is adapted for being connected to plumbing of the shower. At least a portion of the water conduit comprises a hose for enabling movement of the housing or at least a section of the housing along the support bar with the water conduit being connected to the plumbing and the connecting mechanism.

In one embodiment, there is provided a showerhead mounting system typically for installing a showerhead that is generally centrally located in the shower space without altering the existing plumbing of the bathroom and enables a user to easily change the position of the showerhead within the shower space. The showerhead mounting system comprises a support assembly comprising a support bar and a first and a second mounting element connected to a respective first and second end of the support bar. The support assembly is adapted for being placed between two opposing walls of a shower and mounted thereto. A housing is adapted for accommodating the support bar therein such that a top thereof is in contact with the support bar. The housing or at least a section of the housing is movable along the support bar. A connecting mechanism is mounted to a bottom of the housing at a first end thereof such that the first end of the connecting mechanism is protruding through an opening disposed in the bottom of the housing or the at least a movable section of the housing. The first end of the connecting mechanism is adapted for being connected to a showerhead. A water conduit is connected to a second end of the connecting mechanism at a first end thereof. A second end of the water conduit is adapted for being connected to plumbing of the shower. At least a portion of the water conduit comprises a hose for enabling movement of the housing or at least a section of the housing along the support bar with the water conduit being connected to the plumbing and the connecting mechanism. The housing extends the length of the support bar and comprises a plurality of telescopically movable housing sections with a housing center section and at least one housing extension section extending from each of a first end and a second end of the housing center section. The housing center section comprises the connecting mechanism for being connected to the showerhead. A housing end section of each of the at least one housing extension section is mounted to a respective end of the support assembly.

The inventive showerhead mounting system thus provides for the easy installation of a showerhead that is generally centrally located in the shower space without altering or damaging the existing plumbing of the bathroom. The showerhead mounting system also enables a user to easily change the position of the showerhead within the shower space. As a result, the inventive showerhead mounting system provides a personalized and adaptable showering environment without incurring the expense and complexity of traditional installations.

### BRIEF DESCRIPTION OF THE DRAWINGS

Drawings of embodiments are provided herewith and briefly described as follows:

FIG. 1 is a partially transparent front view of one embodiment of the showerhead mounting system described herein;

FIG. 2 is a partially transparent front view of a detail of the showerhead mounting system of FIG. 1;

FIG. 3 is a front view of the housing of the showerhead mounting system of FIG. 1;

FIG. 4 is a front view of a detail of the housing of the showerhead mounting system of FIG. 1;

FIGS. 5-9 are top perspective views of housing sections of the showerhead mounting system of FIG. 1;

FIG. 10 is an exploded top perspective view of an end portion of the showerhead mounting system of FIG. 1;

FIG. 11 is a top perspective view of a component of the end portion of the showerhead mounting system of FIG. 1; and,

FIGS. 12-14 are partially transparent front views of other embodiments of the showerhead mounting system described herein.

### DETAILED DESCRIPTION

Disclosed herein is showerhead mounting system that allows for easy installation of a showerhead that is more centrally located, or generally centrally located, in the shower space without altering or damaging the existing plumbing of the bathroom and enables a user to easily change the position of the showerhead within the shower space.

The showerhead mounting system comprises a support bar for being placed between two opposing walls of a shower and mounted thereto. A housing adapted for accommodating the support bar therein has a connecting mechanism mounted to a bottom thereof such that a first end of the connecting mechanism can be connected to a showerhead. The showerhead mounting system further comprises a water conduit connected to a second end of the connecting mechanism and plumbing of the shower for providing water to the showerhead. The showerhead together with the housing is easily moved along the support bar during use, thus enabling a user to easily change the position of the showerhead within the shower space. The showerhead mounting system disclosed herein, therefore, provides a substantial improvement with respect to ease of installation and creation of a personalized and adaptable showering environment.

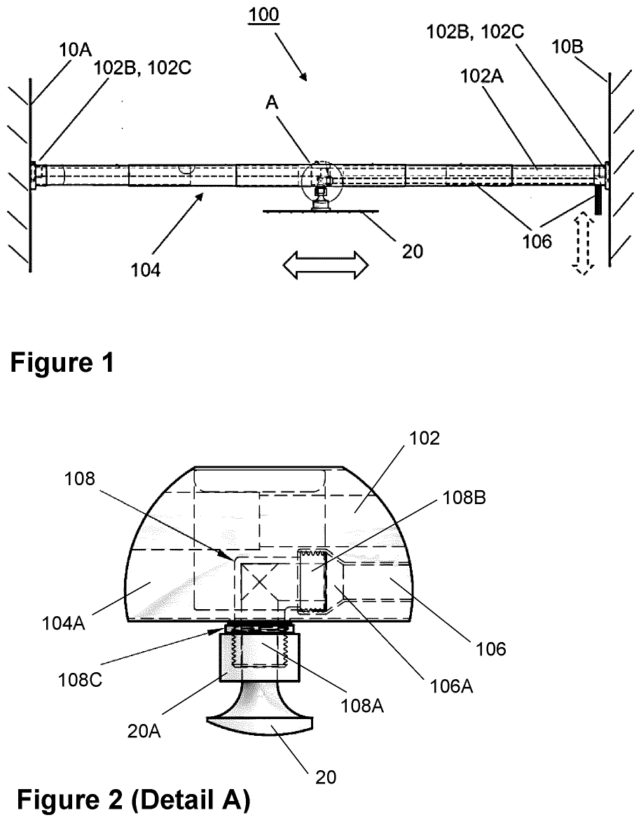

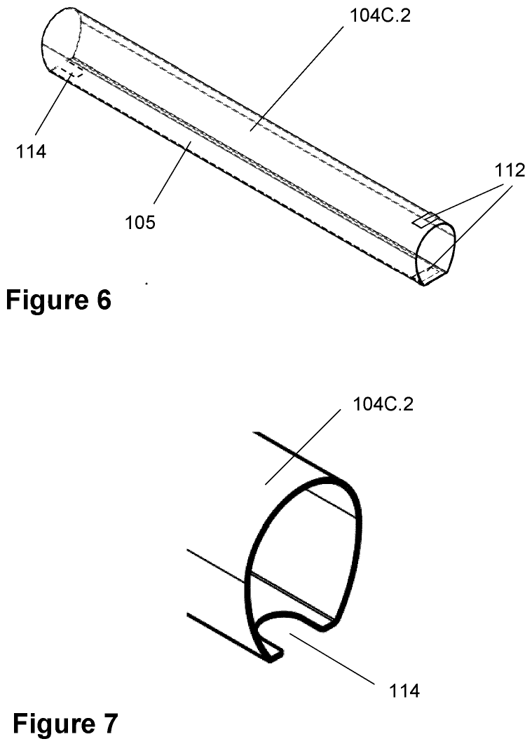

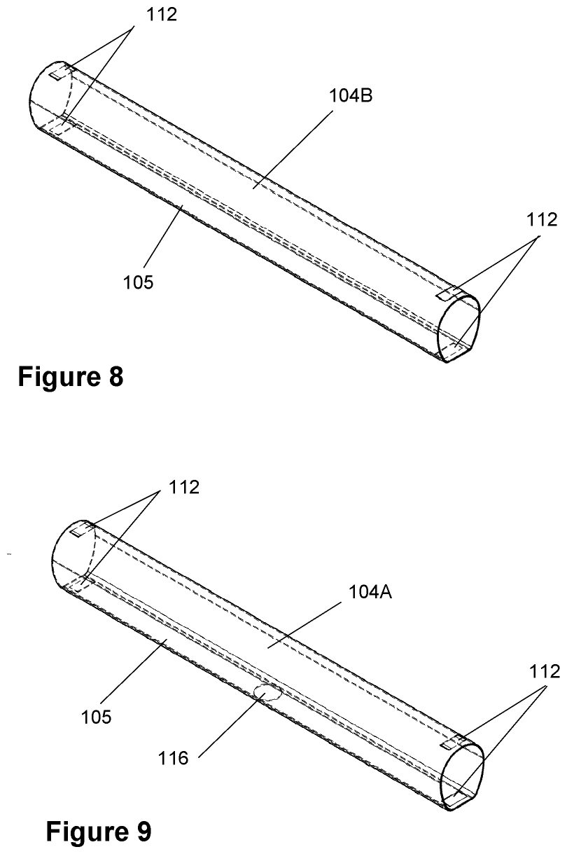

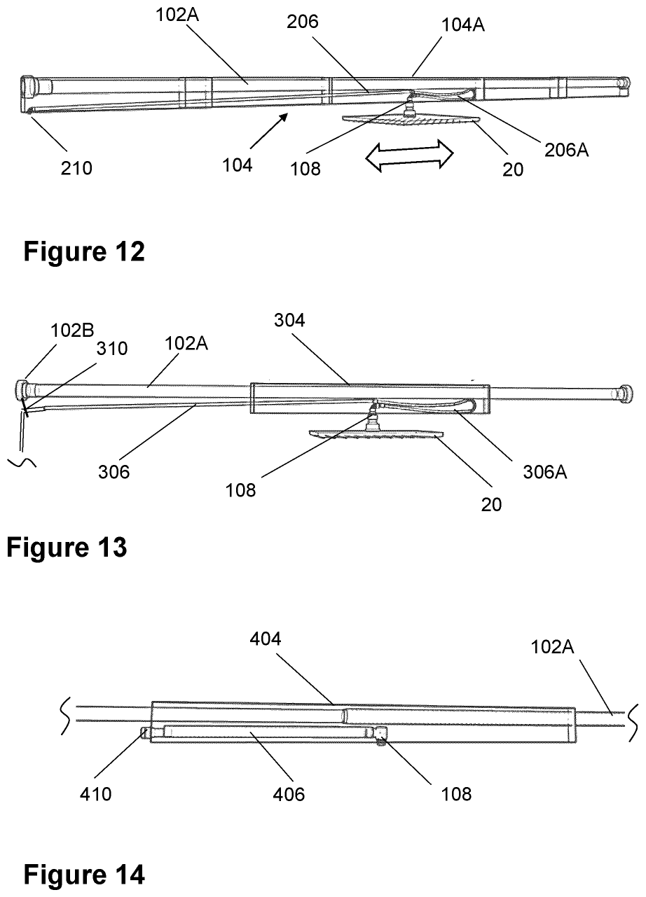

FIGS. 1-11 illustrate one embodiment of the present showerhead mounting system. FIG. 12 illustrates another embodiment of the present showerhead mounting system. FIG. 13 illustrates yet another embodiment of the present showerhead mounting system. FIG. 14 illustrates yet another embodiment of the present showerhead mounting system.

As one example of the showerhead mounting system as shown in FIGS. 1-11, the showerhead mounting system 100 generally comprises a support assembly comprising a support bar 102A and a first and a second mounting element 102B connected to a respective first and second end of the support bar 102A. The support assembly is adapted for being placed between two opposing walls 10A, 10B of a shower and mounted thereto. The support bar 102A may be telescopically movable between an extended position and a retracted position and, furthermore, may be adapted to provide sufficient force acting on the first and the second mounting element 102B for mounting the system 100 through interaction of the first and the second mounting element 102B with the respective wall 10A, 10B. Such support bars are easily adjusted to different distances between the two opposing shower walls 10A, 10B, are easily installed, and provide sufficient stability without damaging the shower walls 10A, 10B. Various configurations of such support bars are commercially available and are disclosed, for example, in U.S. Pat. Nos. 8,925,747B1, 6,216,287B1, 8,479,932B2, US20120284914A1, and US20120241399A1. Alternatively, the mounting elements 102B may be adapted for being mounted to the shower walls 10A, 10B using fasteners such as, for example, an adhesive or screws.

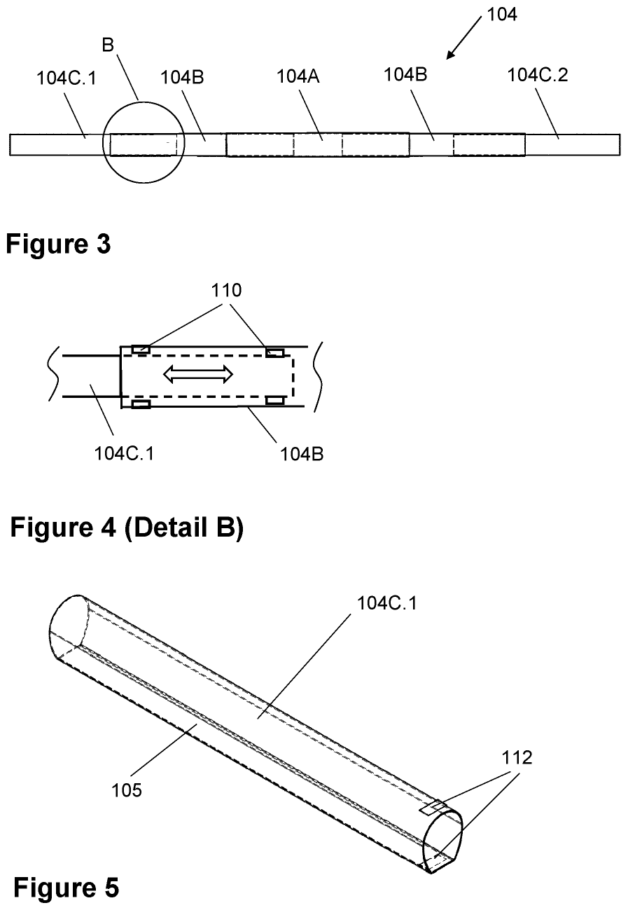

Housing 104 is adapted for accommodating the support bar therein such that a top thereof is in contact with the support bar 102A. The housing 104 extends, for example, the length of the support bar 102A and comprises a plurality of telescopically movable housing sections, in order to provide a seamless and aesthetically pleasing look. As illustrated in FIG. 3, the housing 104 may comprise a housing center section 104A, intermediate housing extension sections 104B extending from each of a first end and a second end of the housing center section 104A and end housing extension sections 104C.1, 104C.2, but is not limited thereto and different numbers of housing sections may be employed. The housing center section 104A and the intermediate housing extension sections 104B are movable along the support bar 102A, while the end housing extension sections 104C.1, 104C.2 are fixedly mounted to the mounting elements 102B, as will be described hereinbelow.

Connecting mechanism 108 is mounted to a bottom of the housing center section 104A at a first end 108A thereof such that the first end 108A of the connecting mechanism 108 is protruding through an opening 116 disposed in the bottom of the housing center section 104A, as illustrated in FIG. 2. The first end 108A of the connecting mechanism 108 is adapted for being connected to a showerhead 20 such as, for example, a commercially available rainfall showerhead. The connecting mechanism may comprise, for example, a 90° elbow fitting or a straight fitting, and threaded first and second ends 108A, 108B utilizing ½ inch BSP threading for widespread applicability in North America but is easily adaptable to standard sizes of other regions. The connecting mechanism 108 may be mounted to the housing center section 104A using threaded nut 108C.

Water conduit 106 is connected to the second end 108B of the connecting mechanism 108 at a first end thereof. The second end of the water conduit 106 is adapted for being connected to the existing plumbing of the shower. The water conduit 106 comprises a hose for enabling movement of the housing center section 104A along the support bar 102A with the water conduit being connected to the plumbing of the shower and the connecting mechanism 108. The water conduit 106 may be provided as a commercially available steel or plastic shower hose having standard sized connectors. While taking a shower the user can easily hold the showerhead 20 with his/her hands and move the showerhead 20 along the support bar 102A to a desired location within the shower space, as indicated by the solid block arrow in FIG. 1. Movement of the showerhead 20 causes the hose 106 to move through an aperture disposed in the housing 104, thus lengthening or shortening the length of the hose 106 between the aperture and the plumbing of the shower, as indicated by the dashed block arrow in FIG. 1.

The housing sections 104A, 104B, 104C.1, and 104C.2 may be tube-shaped having a flat bottom 105 for facilitating mounting of the connecting mechanism 108 thereto, as illustrated in FIGS. 5-9. Various different cross-sectional shapes of the housing sections may be employed depending on design preferences. The housing sections 104A, 104B, 104C.1, and 104C.2 may be made of corrosion-resistant sheet metals such as stainless steel, anodized aluminum, or coated with a waterproof finish. Alternatively, the housing sections 104A, 104B, 104C.1, and 104C.2 may be made of high-quality plastic-based materials such as, for example, Acrylonitrile Butadiene Styrene (ABS) or a blend of PolyCarbonate (PC) and ABS. Adjoined housing sections have differently sized cross sections to allow the same to slide over each other, as illustrated for housing sections 104B and 104C.1 in FIG. 4. In order to prevent the housing sections to separate from each other during movement interlocking elements made of for example, Nylon, are disposed on the outside of the smaller housing section and on the inside of the larger housing section and mounted thereto using a snug fit with respective apertures 112 disposed in the housing sections.

Optionally, seals such as, for example, rubber gaskets made from high-quality silicone, may be disposed between adjoined housing sections for providing a watertight seal.

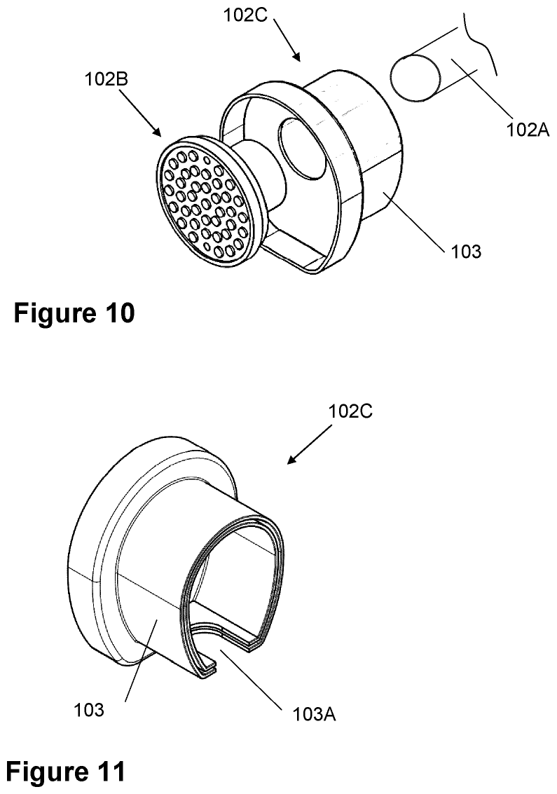

Referring to FIGS. 10 and 11, the showerhead mounting system 100 may comprise end caps 102C covering the respective mounting elements 102B and mounted thereto, for example, via a snug fit, with each of the end caps 102C comprising a mounting portion 103. Housing end sections 104C.1, 104C.2 are mounted to the mounting portion 103 of the respective end caps 102C via, for example, a snug fit. Snug fits are employed to facilitate the installation of the showerhead mounting system 100 but may be replaced using different mounting techniques such as, for example, a clip lock system or screw fasteners. The mounting portion 103 of one end cap 102C comprises a cutout 103A in a bottom thereof such that the same coincides with the cutout 114 in the bottom of the housing end section 104C.2 to form an aperture for enabling movement of the hose 106 therethrough. The mounting elements 102B and the end caps 102C may be made of silicone rubber.

The showerhead mounting system 100 is easily installed by employing the following process:
mounting the support bar 102A to the shower walls 10A, 10B with the housing sections 104B, 104C.1, and 104C.2 in the retracted position such that the mounting elements are securely engaged with the respective shower wall 10A, 10B;
placing the end caps 102C onto the respective mounting elements 102B;
extending the housing from the retracted position and placing the ends of the housing sections 104C.1, and 104C.2 onto the mounting portion 103 of the respective end caps; and,
connecting the hose 106 to the plumbing.

Optionally, the housing center section 104A may be provided with a locking mechanism for securely positioning the same along the support bar 102A. Different configurations of locking mechanisms may be employed such as a twist-lock system, a clamping bracket, or a push-button lock, with each providing secure engagement with the support bar 102A and allowing the user to effortlessly adjust the showerhead's position along the support bar 102A.

Further optionally, the showerhead mounting system 100 may be adapted such that more than one showerhead, for example, two or more rainfall showerheads side by side, can be connected thereto by providing one or more additional connecting mechanisms in the form of T-fittings between the connecting mechanism 108 and the water conduit 106 with the additional connecting mechanisms being connected to each other and the connecting mechanism 108 using a rigid or flexible conduit. Furthermore, the one or more additional connecting mechanisms may be mounted to different housing sections and connected using flexible conduits, thus enabling the user to individually position each showerhead according to his/her preferences.

The shower may include an existing showerhead which, in most showers, is fixed at one end of the shower space. The showerhead mounting system 100 may be connected to the plumbing of the shower by interposing a T-fitting having the second end of the water conduit 106 connected thereto between the plumbing and the existing showerhead, thus providing water simultaneously to the existing showerhead as well as to the showerhead mounted to the showerhead mounting system 100. Alternatively, instead of the T-fitting, an L-Type 3-way valve may be employed enabling switching between the existing showerhead and the shower head mounted to the showerhead mounting system 100 or, further alternatively, a T-Type 3-way valve may be employed enabling switching between the existing showerhead and the shower head mounted to the showerhead mounting system 100, as well as providing water simultaneously to the existing showerhead and the shower head mounted to the showerhead mounting system 100.

The embodiments described hereinbelow are based on the same concept as the showerhead mounting system 100 hereinabove and generally employ the same components with only minor variations as outlined hereinbelow with reference to FIGS. 12-14. In these embodiments, the hose 206 may be disposed inside the housing 104 in a U-shaped manner 206A where space permits. Alternatively, the hose 206 may be disposed such that it extends directly, without a U-shape.

FIG. 12 illustrates another embodiment of the present showerhead mounting system which is similar to the showerhead mounting system 100. Here, the hose 206 is disposed inside the housing 104 in a U-shaped manner 206A for enabling movement of the housing center section 104A with the showerhead 20 along the support bar 102A by adjusting a length of the U-shape 206A. Consequently, the hose 206 remains stationary at the end of the housing 104 at 210. Optionally, the hose 206 may be terminated at 210 and mounted to a universal connecting mechanism, enabling a user to connect a standard shower hose thereto.

FIG. 13 illustrates yet another embodiment of the present showerhead mounting system. Here, the housing 304 is provided as a single piece center housing covering only a portion of the support bar 102A. Guiding structure 310 may be disposed in proximity to a first end of the support bar 102A for guiding the hose therethrough to prevent the same from hanging inside the shower space in proximity to the showerhead 20. For example, the guiding structure 310 may be provided as a ring mounted to the mounting element 102B and adapted for accommodating the hose 306 therethrough. The hose 306 may form a U-shape 306A or may go directly to the guiding structure. Optionally, the housing 304 may be provided with walls placed at both ends with the walls having openings for accommodating the support bar 102A and the hose 306 therethrough.

FIG. 14 illustrates yet another embodiment of the present showerhead mounting system. Here, the water conduit comprises rigid pipe 406 disposed inside the housing 404 and connected to the connecting mechanism 108 and connecting mechanism 410 such as, for example, a standard sized connector, enabling a user to connect a standard shower hose thereto. Optionally, the housing 404 may be provided with walls placed at both ends with the walls having openings for accommodating the support bar 102A therethrough and one of the walls having the connecting mechanism 410 mounted thereto.

The above disclosure and figures are intended to be illustrative and not exhaustive. The description will suggest many variations and alternatives to one of ordinary skill in the art. Those familiar with the art may recognize other equivalents to the specific embodiments described herein within, without departing from the scope thereof.

What is claimed is:

1. A showerhead mounting system comprising:
a support assembly comprising a support bar and a first and a second mounting element connected to a respective first and second end of the support bar, wherein the support assembly is adapted for being placed between two opposing walls of a shower and mounted thereto;
a housing adapted for accommodating the support bar therein such that a top thereof is in contact with the support bar, wherein the housing or at least a section of the housing is movable along the support bar;
a connecting mechanism mounted to a bottom of the housing at a first end thereof such that the first end of the connecting mechanism is protruding through an opening disposed in the bottom of the housing or the at least a movable section of the housing, wherein the first end of the connecting mechanism is adapted for being connected to a showerhead; and,
a water conduit connected to a second end of the connecting mechanism at a first end thereof, wherein a second end of the water conduit is adapted for being connected to plumbing of the shower, wherein at least a portion of the water conduit comprises a hose for enabling movement of the housing or the at least a section of the housing along the support bar with the water conduit being connected to the plumbing and the connecting mechanism.

2. The system of claim 1 comprising a guiding structure disposed in proximity to a first end of the support bar for guiding the hose therethrough during movement of the housing along the support bar.

3. The system of claim 1 wherein the hose is disposed inside the housing in a U-shaped manner for enabling movement of the housing along the support bar by adjusting a length of the U-shape.

4. The system of claim 1 wherein the water conduit comprises:
a first portion disposed inside the housing and connected to the connecting mechanism;
a second connecting mechanism mounted to a first end of the housing and connected to the first portion; and,
a second portion disposed outside the housing and connected to the second connecting mechanism.

5. The system of claim 1 wherein the connecting mechanism comprises a 90° elbow fitting.

6. The system of claim 1 wherein the housing extends the length of the support bar and wherein the housing comprises a plurality of telescopically movable housing sections.

7. The system of claim 6 wherein the housing comprises a housing center section and at least one housing extension section extending from each of a first end and a second end of the housing center section, wherein the housing center section comprises the connecting mechanism for being connected to the showerhead.

8. The system of claim 7 wherein a housing end section of each of the at least one housing extension section is mounted to a respective end of the support assembly.

9. The system of claim 8 comprising a first and a second end cap, wherein each of the first and the second end cap covers the respective first and second mounting element, and wherein each of the first and the second end cap comprises a mounting portion having a respective housing end section connected thereto.

10. The system of claim 9 wherein the mounting portion of one end cap comprises a cutout in a bottom thereof, and wherein the respective housing end section comprises a cutout in a bottom thereof such that the same coincides with the cutout in the bottom of the mounting portion for enabling movement of the hose therethrough.

11. The system of claim 9 wherein the first and the second end cap are connected to the respective first and second mounting element via a snug fit.

12. The system of claim 9 wherein the housing end sections are connected to the respective mounting portions via a snug fit.

13. The system of claim 6 wherein each housing section is tube-shaped.

14. The system of claim 13 wherein each housing section has a flat bottom.

15. The system of claim 1 wherein the support bar is telescopically movable between an extended position and a retracted position.

16. The system of claim 15 wherein the support bar is adapted to provide sufficient force acting on the first and the second mounting element for mounting the system through interaction of the first and the second mounting element with the respective wall.

17. The system of claim 1 comprising a rainfall showerhead mounted to the first end of the connecting mechanism.
